(19) United States
(12) Patent Application Publication
(10) Pub. No.: US 2004/0148825 A1
(43) Pub. Date: Aug. 5, 2004

(54) Collapsible display for retail outlet

(76) Inventors: John Richard Myers, Newton Aycliffe (GB); Graham McGregor, Pelton (GB); Paul Michael Scott, Birtley (GB)

Correspondence Address: Jack Schwartz & Associates, Suite 1507, 1350 Broadway, New York, NY, 10018, US

(21) Appl. No.: 10/714,453

(22) Filed: Nov. 14, 2003

(30) Foreign Application Priority Data
Nov. 21, 2002 (GB) 0227195.5

(51) Int. Cl. G09F 1/10

(52) U.S. Cl. 40/124

(57) ABSTRACT

A collapsible display 1 for a retail outlet is disclosed. The display 1 comprises a body portion 2 having a folded condition and an unfolded condition, and a display portion 3 including a display area 15 for carrying display information. Product supporting shelf portions 4 are pivotably connected between the body portion 2 and display portion 3, such that the display portion 3 is moveable relative to the body portion 2 between a first position, in which the shelf portion 4 are folded flat against the body portion 2 to allow folding of the body portion 2 to its folded condition, and a second position, in which the shelf portions 4 are adapted to support at least one product to be displayed and to retain the body portion 2 in its unfolded condition with the display area 15 protruding from the body portion 2.

The present invention relates to collapsible displays for retail outlets, and relates particularly, but not exclusively, to collapsible displays of cardboard or other sheet material for displaying consumer products, for example food products.

Collapsible displays for use in retail outlets are known in which the display in its assembled condition forms a large container for containing consumer products such as toiletries or food products such as snack foods, and a header card for carrying sales and/or product information relating to the food product and its manufacturer and is collapsible for compact storage and/or transport. Known collapsible displays of this type suffer from the drawbacks that retail staff often have difficulty assembling the foldable display correctly, and the header card carrying sales information is provided as a separate piece from the main body of the display, as a result of which the header card is often lost, severely detracting from the visual impression created by the display.

Preferred embodiments of the present invention seek to overcome the above disadvantages of the prior art.

According to the present invention, there is provided a collapsible display for a retail outlet, the display comprising:—

a first portion having a folded condition and an unfolded condition;

a second portion including a display area for carrying display information; and

at least one product supporting portion pivotably connected between said first and second portions;

wherein said second portion is moveable relative to said first portion between a first position, in which the or each said product supporting portion is folded flat against said first portion to allow folding of said first portion to the folded condition thereof, and a second position, in which the or each said product supporting portion is adapted to support at least one product to be displayed and to retain said first portion in the unfolded condition thereof, and said display area protrudes from said first portion.

This provides the advantage of simultaneously simplifying assembly of the display to its unfolded condition for use in displaying one or more products, while ensuring that the second portion, which may carry important sales information from the point of view of the supplier of the product being displayed, does not become separated from the rest of the display and lost.

The second portion may be located substantially inside said first portion in said first position.

This provides the advantage of making the display more compact in its folded condition, enabling more convenient storage and/or transport of the display.

The second portion may be attached to said first portion adjacent an end of said second portion remote from said display area.

This provides the advantage of assisting correct location of the second portion relative to the first portion when in said second position, which may otherwise prevent correct operation of the display.

The display may further comprise at least one retaining device for retaining the or each said product supporting portion in a position in which said product supporting portion is adapted to support at least one product and to prevent folding of said first portion to said folded condition.

At least one said retaining device may comprise at least one respective retaining member for engaging the or each said product supporting portion.

The or each said retaining member may be formed integrally with said first portion.

This provides the advantage of a simplifying construction of the display.

In a preferred embodiment, said first portion is formed from at least one sheet material, and the or each said retaining member is adapted to be displaced out of the plane of the or each sheet material adjacent thereto.

In a preferred embodiment, at least one said retaining member is provided with at least one respective aperture to be engaged by a user of the display to enable folding of at least one said product supporting portion against said first portion.

This provides the advantage of making the display easier to fold and therefore easier to re-use.

The display may further comprise at least one display member for carrying graphic information and adapted to be mounted to said first portion.

The or each said display member may be separable from said first portion.

This provides the advantage of maximising the extent to which components of the display can be formed from a single rectangular sheet of material, since the or each display member can be formed from off-cuts of the sheet from which the first and/or second portion are formed.

The first portion may comprise at least one foldable portion for retaining a respective said display member in position.

In a preferred embodiment, at least one said product supporting portion is connected to said first and/or second portion by means of at least one respective tab on one of said product supporting portion, said first portion or said second portion, and at least one respective aperture on another of said product supporting portion, said first portion or said second portion for receiving said tab.

This provides the advantage of reducing the amount of gluing necessary to construct the display, which in turn reduces the cost and increases the ease of manufacture of the display.

Preferred embodiments of the invention will now be described, by way of example only and not in any limitative sense, with reference to the accompanying drawings, in which:—

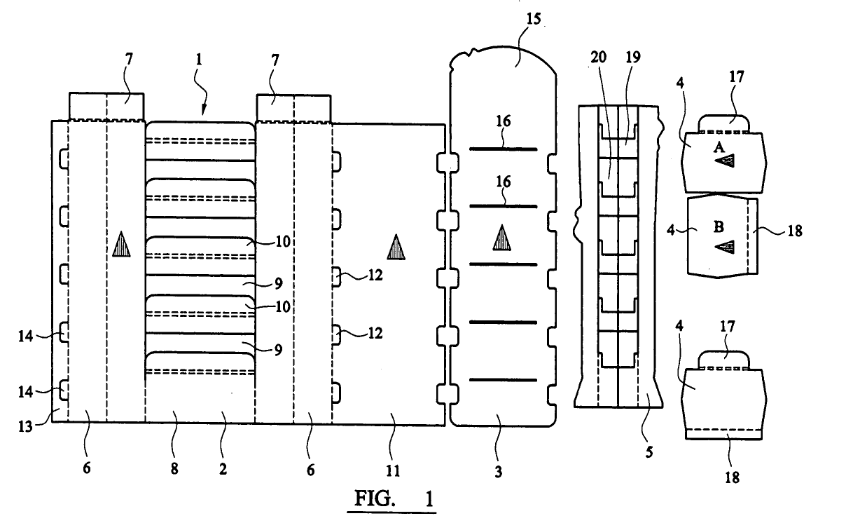

FIG. 1 shows the separate components of a collapsible display of a first embodiment of the present invention;

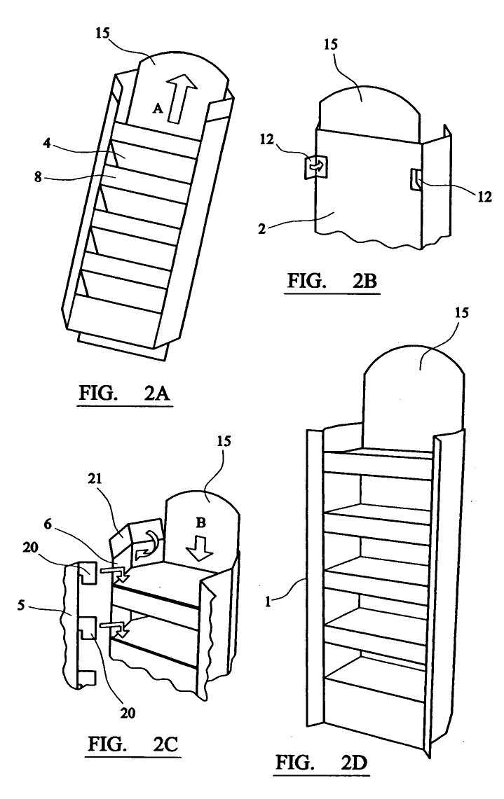

FIGS. 2a to 2d show the steps taken to unfold the assembled display of FIG. 1; and

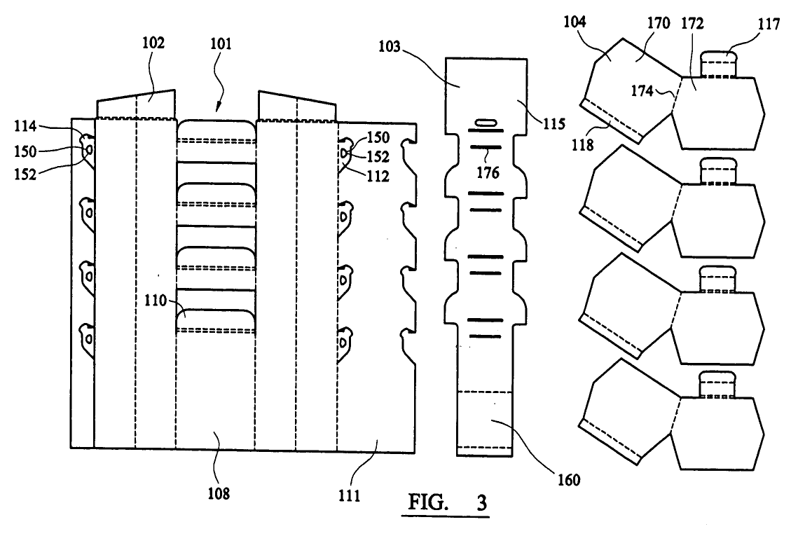

FIG. 3 corresponds to FIG. 1 and shows the separate components of a second embodiment of the present invention.

Referring to FIG. 1, a retail display (1) of a first embodiment of the invention comprises a first, body portion (2), a second, display portion (3), a plurality of product supporting, shelf portions (4), and a pair of display members in the form of sidewings (5). The body portion (2), display portion (3) and sidewings (5) are cut from a single rectangular sheet of cardboard or other suitable lightweight sheet material.

The body portion (2) has a pair of sides (6), each of which is provided with central fold lines (7), the sides (6) being separated by a front panel (8) provided with a series of apertures (9) and corresponding foldable flaps (10). The body portion (2) is also provided with a rear panel (11) extending from one of the sides (6) and provided with foldable tabs (12), the purpose of which will be explained in greater detail below, and a further panel (13) extending from the other side panel (6) and provided with foldable tabs (14), corresponding to foldable tabs (12). To assemble the body portion, the panels (11) and (13) are glued together, to form a generally cuboid-shaped box which can be folded flat by folding the sides (6) outwardly along fold lines (7).

The display portion (3) has a display area (15) for carrying sales information, and is provided with a series of slots (16), each of which receives a flap (17) of a corresponding shelf portion (4), the flap (17) then being glued in position against the display portion (3). Each shelf portion (4) is also provided with an edge flap (18) which is glued to a corresponding flap (10) of the body portion (2) so that the display portion (3) is connected to the body portion (2) by the shelf portions (4), but can be moved in the direction of arrow A in FIG. 2a.

Each of the sidewings (5) is provided with cut-outs (19) to form generally L-shaped tabs (20) for location between corresponding shelf portions (4) and the adjacent upper part of a side (6) of body portion (2) to locate the sidewings (5) in position on the unfolded body portion (2).

Referring to FIG. 2a, the display is initially provided in a compact, folded condition for transport purposes, in which the shelf portions (4) are folded flat against the front panel (8) of body portion (2), and the side panels (6) are folded in half outwardly along fold lines (7) so that the display is generally flat. In this condition, the display area (15) of display portion (3) is located downwards (in the direction of arrow B in FIG. 2c) relative to its unfolded condition so that the display portion (3) is located substantially within body portion (2). In order to bring the display into its unfolded condition, the display area (15) of display portion (3) is moved relative to the body portion (2) in the direction of arrow A in FIG. 2a. This brings the shelf portions (4) into a horizontal orientation relative to the body portion (2) to provide shelves for displaying consumer products, for example toiletries or food products such as snack products, while at the same time maintaining the body portion (2) in its unfolded condition.

Referring now to FIG. 2b, in order to maintain the shelves in position, the tabs (12), (14) of body portion (2) are displaced inwardly to prevent the shelves from being folded back against the body portion, and to retain the display portion (3) in a position in which the display area (15) is visible. The side wings (5) are then mounted to the display as shown in FIG. 2c by locating tabs (20) between shelf portions (4) and the inner side walls (6) of body portion (2), and then folding side flaps (21) downwardly to retain the sidewings (5) in position to produce the assembled display shown in FIG. 2d.

Referring to FIG. 3, in which parts common to the embodiment of FIGS. 1 and 2 are denoted by like reference numerals but increased by 100, a retail display 101 of a second embodiment of the invention has a body portion 102 in which foldable tabs 112, 114 are provided with curved slits 150 so that the material of tabs 112, 114 can be displaced to form apertures 152. The apertures 152 enable a user to pull the displaced tabs 112, 114 back into the plane of the front 108 or rear 111 of the body portion 102 to facilitate folding of the display 101 so that the display 101 can be re-used. The tabs 112, 114 are also larger than the tabs 12, 14 of the embodiment of FIGS. 1 and 2 to assist in locating the corresponding shelf portions 104 in position.

The display 101 also has a display portion 103 having a bottom part 160 at its end remote from display area 115. The bottom part 160 is glued to a lower part of the body portion 102 so that the movement of the display area 115 relative to the body portion 102 is limited. This prevents the display portion 103 from being pulled up too far relative to the body portion 102, which in turn minimises the risk of it not being possible to displace tabs 112, 114 inwardly to maintain the shelf portions 104 in position.

The shelf portions 104 of the embodiment of FIG. 3 are formed from a single sheet of material and have a first part 170 from which edge flap 118 extends and a second part 172 from which flap 117 extends, the first and second parts 170, 172 being joined at fold line 174. In order to assemble the display 101, the first and second parts 170, 172 are folded together along fold line 174, and the edge flap 118 is glued to the corresponding flap 110 of body portion 102. However, the flap 117 is passed through a pair of slots 116, 176 in display portion 103, as a result of which less gluing is required than in the embodiment of FIGS. 1 and 2, which in turn reduces the cost and complexity of assembly of the display 101.

It will be appreciated by persons skilled in the art that the above embodiments have been described by way of example only and not in any limitative sense, and that various alterations and modifications are possible without departure from the scope of the invention thus defined by the appended claims. For example, the components of the above embodiments have been described as glued together, but it will be understood by persons skilled in the art that other method of constructions may be used, such as locating separate components in position relative to each other by means of cooperating lugs and slots provided on the components.

1. A collapsible display for a retail outlet, the display comprising:—
a first portion having a folded condition and an unfolded condition;
a second portion including a display area for carrying display information; and
at least one product supporting portion pivotably connected between said first and second portions;
wherein said second portion is moveable relative to said first portion between a first position, in which the or each said product supporting portion is folded flat against said first portion to allow folding of said first portion to the folded condition thereof, and a second position, in which the or each said product supporting portion is adapted to support at least one product to be displayed and to retain said first portion in the unfolded condition thereof, and said display area protrudes from said first portion.

2. A display according to claim 1, wherein the second portion is located substantially inside said first portion in said first position.

3. A display according to claim 1, wherein said second portion is attached to said first portion adjacent an end of said second portion remote from said display area.

4. A display according to claim 1, further comprising at least one retaining device for retaining the or each said product supporting portion in a position in which said product supporting portion is adapted to support at least one product and to prevent folding of said first portion to said folded condition.

5. A display according to claim 4, wherein at least one said retaining device comprises at least one respective retaining member for engaging the or each said product supporting portion.

6. A display according to claim 5, wherein the or each said retaining member is formed integrally with said first portion.

7. A display according to claim 6, wherein said first portion is formed from at least one sheet material, and the or each said retaining member is adapted to be displaced out of the plane of the or each sheet material adjacent thereto.

8. A display according to claim 5, wherein at least one said retaining member is provided with at least one respective aperture to be engaged by a user to enable folding of at least one said product supporting portion against said first portion.

9. A display according to claim 1, further comprising at least one display member for carrying graphic information and adapted to be mounted to said first portion.

10. A display according to claim 9, wherein the or each said display member is separable from said first portion.

11. A display according to claim 10, wherein the first portion comprises at least one foldable portion for retaining a respective said display member in position.

12. A display according to claim 1, wherein at least one said product supporting portion is connected to said first and/or second portion by means of at least one respective tab on one of said product supporting portion, said first portion or said second portion, and at least one respective aperture on another of said product supporting portion, said first portion or said second portion for receiving said tab.
